(19) United States
(12) Patent Application Publication
(10) Pub. No.: US 2008/0106542 A1
(43) Pub. Date: May 8, 2008

(54) DISPLAY SYSTEM AND METHOD FOR DRIVING THE SAME

(76) Inventors: Dong-Won PARK, Cheonan-si (KR); Myeong-Su Kim, Cheonan-si (KR); Seung-Hwan Moon, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/934,658

(22) Filed: Nov. 2, 2007

(30) Foreign Application Priority Data
Nov. 2, 2006 (KR) 10-2006-0108008

(51) Int. Cl. G09G 5/00

(52) U.S. Cl. 345/212; 345/204

(57) ABSTRACT

A display apparatus that can conserve power without compromising general display quality is presented. In a display system including a main control apparatus and a display apparatus, the main control apparatus generates an image control signal having an image data, and a main clock signal that changes from a first frequency to a second frequency in response to a change in image mode from a first image mode to a second image mode. The change from the first frequency to the second frequency includes changing through at least one intermediate frequency stage between the first frequency and the second frequency. By maintaining the change of frequency shift small (i.e., less than a predetermined maximum change), operation in emergency mode is avoided even when the frequency shift is sudden. The display apparatus receives the image control signal and the main clock signal to display an image.

This application claims priority under 35 U.S.C. § 119 to Korean Patent Application No. 2006-108008 filed on Nov. 2, 2006 in the Korean Intellectual Property Office (KIPO), the content of which is herein incorporated by reference in its entirety.

### BACKGROUND OF THE INVENTION

1. Field of the Invention

The present invention relates to a display system and a method for driving the display system. More particularly, the present invention relates to a display system capable of decreasing power consumption and a method of driving the display system.

2. Description of the Related Art

Generally, a liquid crystal display (LCD) apparatus is thin, light, and requires low power consumption. These characteristics make LCD apparatus especially useful for incorporation in laptops. The LCD apparatus includes an LCD panel displaying an image using light transmissivity of a liquid crystal, a backlight assembly disposed under the LCD panel to provide light to the LCD panel, and a driving part driving the LCD panel.

The LCD panel includes a first substrate, a second substrate, and a liquid crystal layer disposed between the first and second substrates. The first substrate includes gate lines and data lines extending perpendicularly to each other, thin film transistors (TFTs) electrically connected to the gate and data lines, and pixel electrodes electrically connected to the TFTs. The second substrate includes color filters positioned to align with the pixel electrodes and a common electrode formed over the second substrate.

The driving part includes a timing control part, a data driving part and a gate driving part. The data driving part is electrically connected to the data lines to apply a data signal to the data lines. The gate driving part is electrically connected to the gate lines to apply a gate signal to the gate lines. The timing control part receives an image control signal from outside and controls the data driving part and the gate driving part.

Generally, the LCD apparatus displays an image with a unit clock frequency of 60 Hz (i.e., the LCD apparatus displays the image 60 times per second).

The amount of power consumed by the LCD apparatus is proportional to the clock frequency. Thus, when the LCD apparatus is driven with the same clock frequency of 60 Hz regardless of the kind of image that is displayed, the power consumption of the LCD apparatus per unit time is constant.

When the LCD apparatus is part of a laptop, the power source is often limited to the battery in the laptop. In this situation, driving the LCD apparatus at a constant clock frequency of 60 Hz may drain the battery of charge faster than desired. A way of extending the battery life would be desirable.

### BRIEF SUMMARY OF THE INVENTION

The present invention provides a display apparatus capable of decreasing power consumption by changing a clock frequency depending on an image mode.

The present invention also provides a method for driving the display apparatus.

In one aspect, the invention is a display system that includes a main control apparatus and a display apparatus. The main control apparatus generates an image control signal having an image data, and a main clock signal that changes from a first frequency to a second frequency in response to a change in image mode from a first image mode to a second image mode. The change from the first frequency to the second frequency includes changing through at least one intermediate frequency stage between the first frequency and the second frequency. The display apparatus receives the image control signal and the main clock signal to display an image.

In another aspect, the invention is a display system that includes a main control apparatus, a frequency change part and a display apparatus. The main control apparatus generates an image control signal and a first main clock signal. The frequency change part receives the first main clock signal to output a second main clock signal when the first main clock signal changes from a first frequency to a second frequency. This change from the first frequency to the second frequency includes the second main clock signal changing through at least one intermediate frequency stage between the first frequency and the second frequency. The display apparatus receives the image control signal and the second main clock signal to display an image.

In yet another aspect, the invention is a method for driving a display system. The method includes generating a main clock signal having an image control signal and a first frequency from a main control apparatus to drive an image in a first mode. The main clock signal is sequentially changed through intermediate frequency stages between the first frequency to a second frequency. An image is displayed to an outside using a display apparatus receiving the main control signal and the main clock signal.

According to the present invention, the frequency of the main clock signal is sequentially changed through intermediate frequency stages so that the display apparatus may reduce power consumption without triggering an emergency mode.

### BRIEF DESCRIPTION OF THE DRAWINGS

The above and other features and advantages of the present invention will become more apparent by describing in detailed embodiments thereof with reference to the accompanying drawings, in which:

FIG. 1 is a block diagram illustrating a display system according to a first embodiment of the present invention;

FIG. 2 is a block diagram explaining power consumption according to a clock frequency of the display system in FIG. 1;

FIG. 3 is a detailed block diagram of a clock signal generating part of a main control apparatus in FIG. 1;

FIG. 4 is a detailed block diagram of the display apparatus in FIG. 1;

FIG. 5 is a detailed block diagram of a timing control part of the display apparatus in FIG. 4;

FIG. 6 is a signal view illustrating a variation of a mode selection signal, when a frequency of a main clock signal is changed from 60 Hz to 50 Hz in FIG. 5;

FIG. 7 is a signal view illustrating a variation of a mode selection signal, when a frequency of a main clock signal is changed from 60 Hz to 59 Hz in FIG. 5;

FIG. 8 is a block diagram explaining that a frequency of a main clock signal is changed from 60 Hz to 50 Hz by a change of 1 Hz in the display system in FIG. 1;

FIG. 9 is a block diagram explaining that a frequency of a main clock signal is changed from 60 Hz to 50 Hz by a change of 0.5 Hz in the display system in FIG. 1; and

FIG. 10 is a block diagram illustrating a display system according to a second embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as being limited to the embodiments set forth herein. These embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with Reference to the accompanying drawings.

### Embodiment 1

### Display System

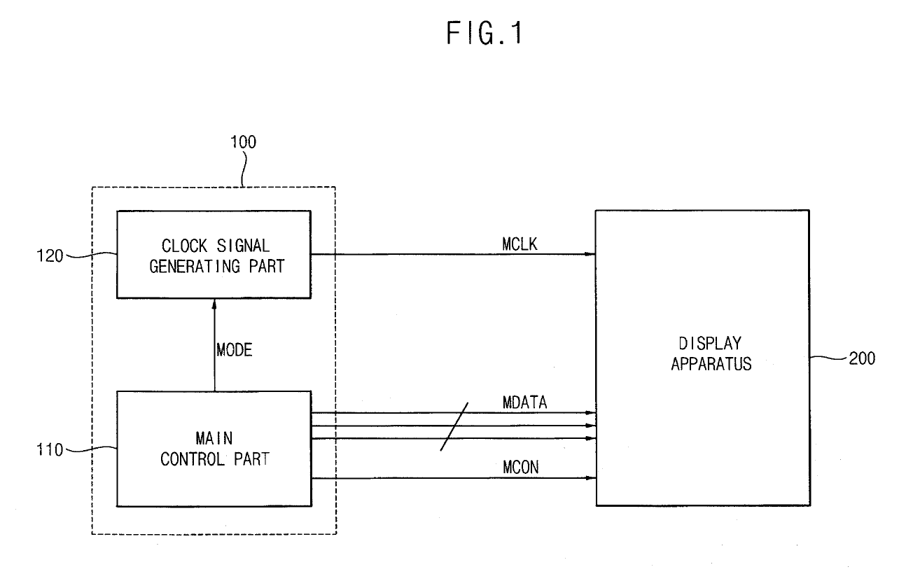

FIG. 1 is a block diagram illustrating a display system according to a first embodiment of the present invention.

Referring to FIG. 1, the display system according to the present embodiment includes a main control apparatus 100 and a display apparatus 200 controlled by the main control apparatus 100 to display an image. For example, the display system may be a portable laptop.

The main control apparatus 100 includes a main control part 110 to output an image control signal to the display apparatus 200, and a clock signal generating part 120 to output a main clock signal MCLK to the display apparatus 200.

Particularly, the main control part 110 generates a main image signal MDATA and a main control signal MCON and outputs the main image signal MDATA and the main control signal MCON to the display apparatus 200. In this case, the main image signal MDATA includes red, blue and green image data, and the main control signal MCON includes various control signals other than the image data.

The main control part 110 may output a mode decision signal MODE deciding an image mode to the clock signal generating part 120. For example, the image mode includes a first image mode displaying a dynamic image such as a movie, and a second image mode displaying a static image such as an OA program. In FIG. 1, the mode decision signal MODE is outputted from the main control part. Alternatively, the mode decision signal MODE may be generated from other elements (e.g., an outside element), and may be fed to the clock signal generating part 120.

The clock signal generating part 120 receives the mode decision signal MODE from the main control part 110 and outputs the main clock signal MCLK to the display apparatus 200. For example, when the first image mode displays the image with a first frequency and the second image mode displays the image with a second frequency lower than the first frequency, the clock signal generating part 120 outputs the main clock signal MCLK having one of the first and second frequencies as indicated by the mode decision signal MODE.

The display apparatus 200 receives the main image signal MDATA, the main control signal MCON and the main clock signal MCLK from the main control apparatus 100 and displays the image. For example, the display apparatus 200 is displayed with the first image mode when the main clock signal MCLK having the first frequency is applied, and the display apparatus 200 is displayed with the second image mode when the main clock signal MCLK having the second frequency is applied.

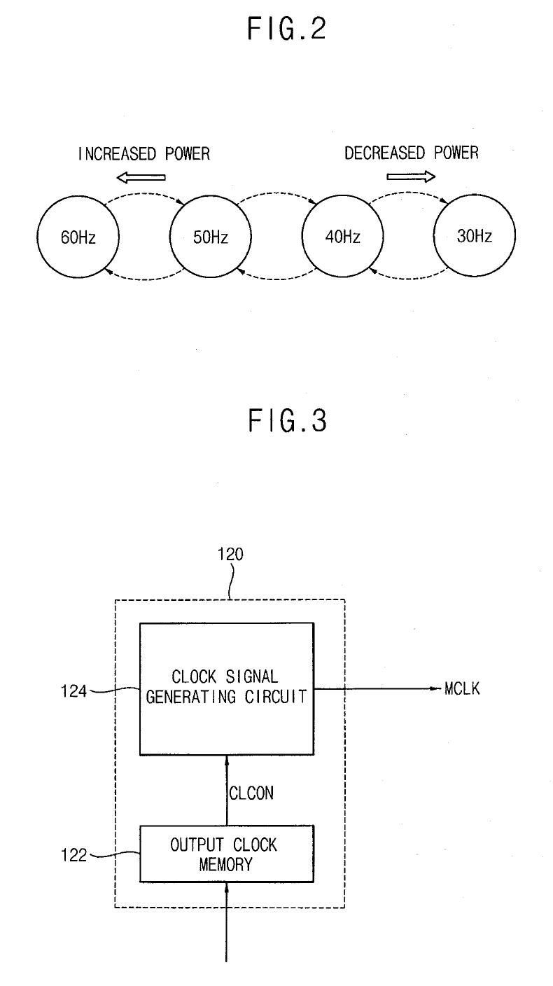

FIG. 2 is a block diagram explaining power consumption according to a clock frequency of the display system in FIG. 1.

Referring to FIG. 2, in the display apparatus 200 according to the present embodiment, power consumption of the display apparatus 200 per unit time is dependent on the frequency of the main clock signal MCLK. For example, the main clock signal MCLK may have frequencies of 60 Hz, 50 Hz, 40 Hz and 30 Hz. Of these four frequencies, the power consumption of the display apparatus 200 is the highest when the main clock signal MCLK has the frequency of 60 Hz, and the power consumption is the lowest when the main clock signal MCLK has the frequency of 30 Hz.

Thus, the power consumption of the display apparatus 200 increases as the main clock signal MCLK increases, and the power consumption decreases as the main clock signal MCLK decreases. However, the display apparatus 200 may display a better image with fewer flickers as the frequency increases.

When the display apparatus 200 displays the image by using one of the first and second image modes, the power consumption of the display apparatus 200 may be decreased in displaying the image by using the second frequency, which is lower than the first frequency.

FIG. 3 is a detailed block diagram of a clock signal generating part of a main control apparatus in FIG. 1.

Referring to FIG. 3, the clock signal generating part 120 of the present embodiment may include an output clock memory 122 and a clock signal generating circuit 124.

The output clock memory 122 receives the mode decision signal MODE from the main control part 110 or another element and stores a clock frequency that is to be outputted. The output clock memory 122 applies an output clock control signal CLCON to control the clock signal generating circuit 124 based on the saved clock frequency.

The clock signal generating circuit 124 receives the output clock control signal CLCON and generates the main clock signal MCLK. The frequency of the main clock signal MCLK depends on the output clock control signal CLCON.

For example, when the main clock signal having the first frequency is outputted from the clock signal generating circuit 124 and the second frequency is stored in the output clock memory 122, the clock signal generating circuit 124 outputs the main clock signal MCLK based on the second frequency that is stored in the output clock memory 122. In shifting from the first frequency to the second frequency, the clock frequency of the main clock signal MCLK passes through intermediate frequency stages having frequencies between the first frequency and the second frequency. More detailed descriptions about this shift in frequency will follow referring to additional figures.

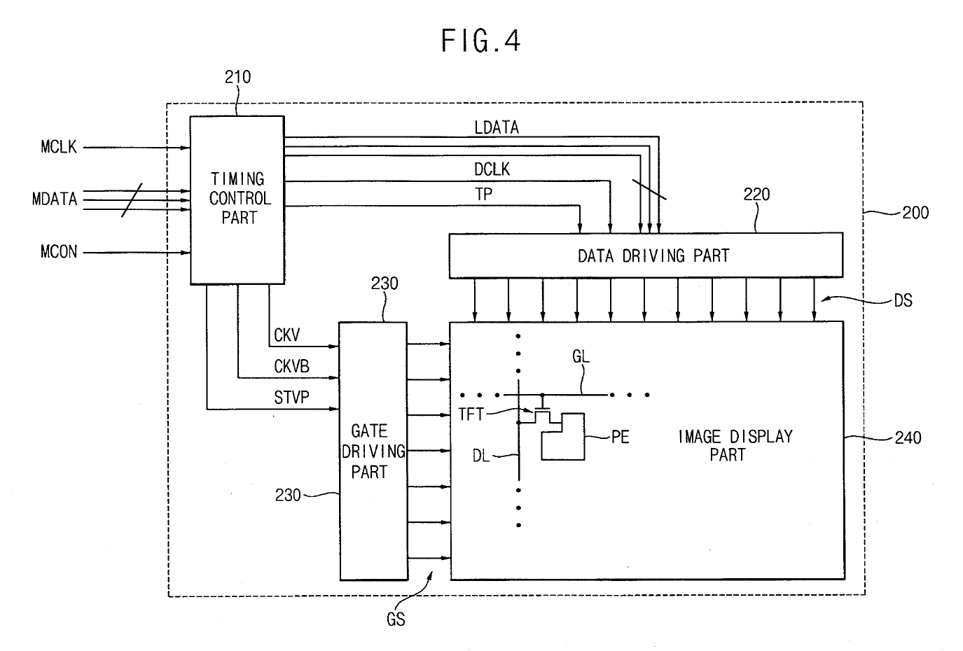

FIG. 4 is a detailed block diagram of the display apparatus in FIG. 1.

Referring to FIG. 4, the display apparatus 200 according to the present embodiment includes a timing control part 210, a data driving part 220, a gate driving part 230 and an image display part 240.

The timing control part 210 receives the main image signal MDATA, the main control signal MCON and the main clock signal MCLK from the main control apparatus 100 and outputs a data driving control signal and a gate driving control signal. The data driving control signal and the gate driving control signal are generated in response to the main image signal MDATA, the main control signal MCON, and the main clock signal MCLK. In this case, the data driving control signal includes a data image signal LDATA, a data output signal TP and a data clock signal DCLK. The gate driving control signal includes a first gate control output signal CKV, a second gate control output signal CKVB and a gate start output signal STVP.

The timing control part 210 controls a data driving part 220 and a gate driving part 230 to display an image in either a normal mode or an emergency mode according to a frequency adjustment change of the main clock signal MCLK.

For example, when the frequency adjustment change of the main clock signal MCLK is less than or equal to a predetermined maximum change, the timing control part 210 controls the data driving part 220 and the gate driving part 230 to display the image in the normal mode. When the change of the main clock signal MCLK exceeds the predetermined maximum change, the timing control part 210 controls the data driving part 220 and the gate driving part 230 to display the image in the emergency mode. In this case, the normal mode is a period in which the display apparatus normally displays the image, and the emergency mode is a period in which the display apparatus does not display the image or abnormally displays an arbitrary image due to a frequency malfunction of the main clock signal MCLK.

More detailed descriptions on the timing control part will follow.

The data driving part 220 receives the data driving control signal and outputs a data signal DS in response to the data driving control signal. For example, the data driving part 220 receives the data image signal LDATA, the data clock signal DCLK and the data output signal TP from the timing control part 210 and applies the data signal DS to the image display part 240.

In this case, the data image signal LDATA corresponding to the main image signal MDATA includes red, green and blue image data. The data output signal TP induces the data driving part 220 to output the data signal DS to the image display part 240. The data clock signal DCLK synchronizes the data image signal LDATA and the data output signal TP.

The gate driving part 230 receives the gate driving control signal and outputs a gate signal GS in response to the gate driving control signal. For example, the gate driving part 230 receives the first gate control output signal CKV, the second gate control output signal CKVB and the gate start output signal STVP to apply the gate signal GS to the image display part 240.

In this case, the gate control output signal CKV controls the gate signal GS generated from the gate driving part 230. The gate control output signal CKVB also controls the gate signal GS and is a reverse of the first gate control output signal CKV. The gate start output signal STVP informs a start of the gate signal GS in the gate driving part 230.

The image display part 240 receives the data signal DS and the gate signal GS and displays the image in response to the data signal DS and the gate signal GS. For example, the image display part 240 includes an array substrate (not shown), a color filter substrate (not shown) and a liquid crystal layer (not shown).

The array substrate includes a gate line GL, a data line DL, a thin film transistor TFT and a pixel electrode PE. The gate line GL is formed along a first direction, and the data line DL is formed along a second line perpendicular to the first direction. The thin film transistor TFT is electrically connected to the gate line GL and the data line DL and receives the gate signal GS and the data signal DS. The pixel electrode PE is formed in a unit pixel that is defined by the gate and data lines GL and DL.

The color filter substrate is disposed substantially parallel to the array substrate and includes a color filter corresponding to the pixel electrode PE and a common electrode formed over the color filter substrate. In this case, the color filter typically includes a red color filter, a green color filter, and a blue color filter, although this is not a limitation of the invention.

The liquid crystal layer is disposed between the array substrate and the color filter substrate. The orientation of liquid crystals in the liquid crystal layer changes according to an electric field generated between the pixel electrode and the common electrode. The orientation of the liquid crystals affects light transmission through the liquid crystal layer, and light transmission is controlled by the voltages applied to the pixel electrode and the common electrode to display the image.

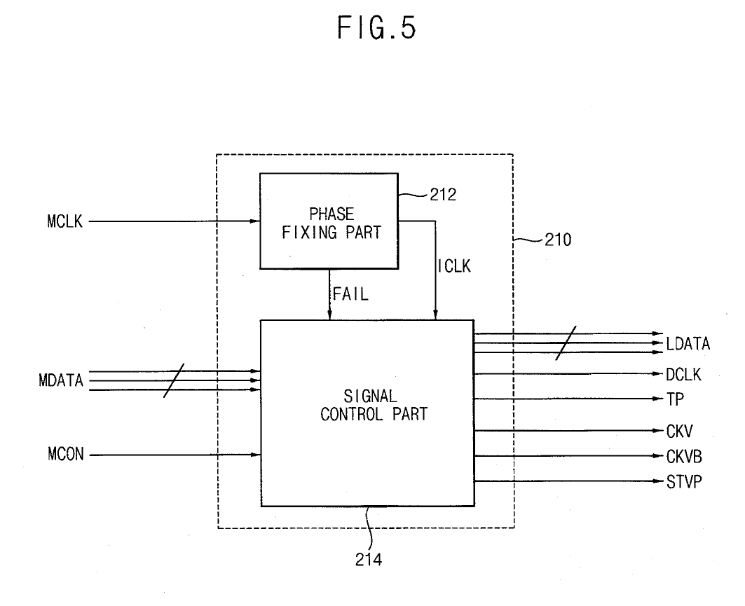

FIG. 5 is a detailed block diagram of a timing control part of the display apparatus in FIG. 4.

Referring to FIG. 5, the timing control part 210 according to the present embodiment includes a phase fixing part 212 and a signal control part 214.

The phase fixing part 212 receives the main clock signal MCLK from the main control apparatus 100 to output an inner clock signal ICLK having a fixing frequency. For example, the phase fixing part 212 is a circuit having a phase locked loop (PLL).

The phase fixing part 212 outputs a mode selection signal FAIL to the signal control part 214. The mode selection signal FAIL selects one of the normal and emergency modes according to whether or not the frequency adjustment change of the main clock signal MCLK is less than the predetermined maximum change.

For example, when the frequency adjustment change of the main clock signal MCLK is less than or equal to the predetermined maximum change, the phase fixing part 212 outputs the mode selection signal FAIL having a high level value. When the frequency adjustment change of the main clock signal MCLK exceeds the predetermined maximum change, the phase fixing part 212 outputs the mode selection signal FAIL having a low level value.

The signal control part 214 receives the main image signal MDATA, the main control signal MCON, and the mode selection signal FAIL to output the data driving control signal and the gate driving control signal in response to the main image signal MDATA, the main control signal MCON and the mode selection signal FAIL. For example, the signal control part 214 receives the main image signal MDATA and the main control signal MCON from the main control apparatus 100 and receives the mode selection signal FAIL from the phase fixing part 212. Then, the signal control part 214 outputs the data image signal LDATA, the data output signal TP and the data clock signal DCLK to control the data driving part 220, and outputs the first gate control output signal CKV, the second gate control output signal CKVB and the gate start output signal STVP to control the gate driving part 230.

When the mode selection signal FAIL having the high level value is received, the signal control part 214 controls the data driving part 220 and the gate driving part 230 to drive the image in normal mode. When the mode selection signal FAIL having the low level value is received, the signal control part 214 controls the data driving part 220 and the gate driving part 230 to drive the image in emergency mode.

Hereinafter, the variation of the mode selection signal FAIL according to the frequency of the main clock signal MCLK will be explained when the predetermined maximum change is about 1 Hz.

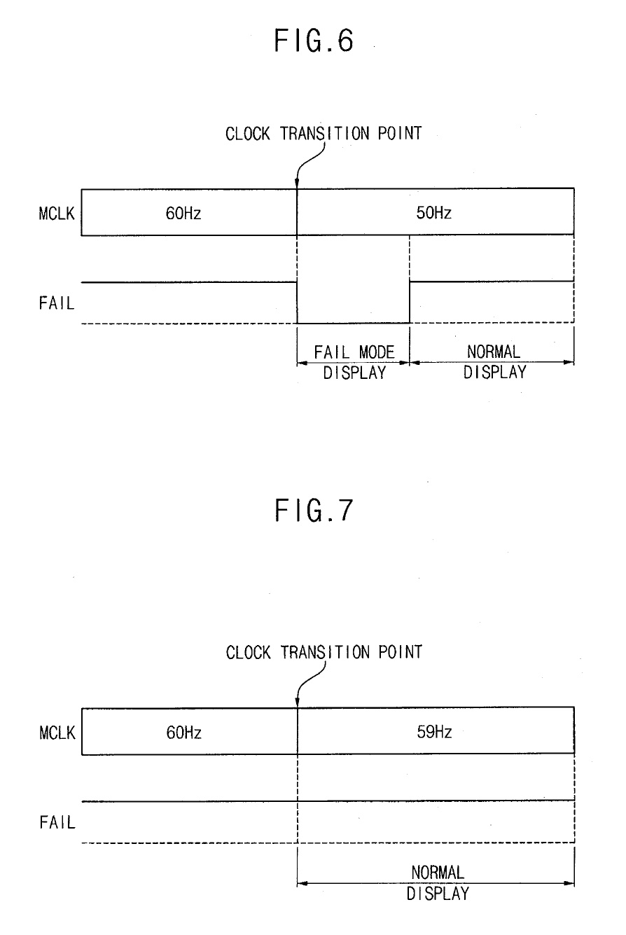

FIG. 6 is a signal view illustrating a shift in the mode selection signal when the frequency of a main clock signal changes from 60 Hz to 50 Hz in FIG. 5.

Referring to FIG. 6, the frequency of the main clock signal MCLK is changed from 60 Hz to 50 Hz. When this happens, after the mode selection signal FAIL has the high level value, the mode selection signal FAIL has the low level value for a predetermined time, for example about 2 or 3 frames from the point where the frequency of the main clock signal MCLK changed. Then, the mode selection signal FAIL has the high level value again because the frequency adjustment change of the main clock signal MCLK is over the predetermined maximum change of 1 Hz.

Thus, when the frequency of the main clock signal MCLK is changed from 60 Hz to 50 Hz, the display apparatus 200 displays the image in the emergency mode for about 2 or 3 frames, and then the display apparatus 200 displays the image in the normal mode.

FIG. 7 is a signal view illustrating the response of a mode selection signal when the frequency of a main clock signal changes from 60 Hz to 59 Hz in FIG. 5.

Referring to FIG. 7, the frequency of the main clock signal MCLK is changed from 60 Hz to 59 Hz. When this happens, the mode selection signal FAIL continuously has the high level value because the frequency adjustment change of the main clock signal MCLK is within the predetermined maximum change of 1 Hz.

Thus, when the frequency of the main clock signal MCLK is changed from 60 Hz to 59 Hz, the display apparatus 200 continuously displays the image in the normal mode.

In the present embodiment, when the first image mode driven by the first frequency is changed to the second image mode driven by the second frequency different from the first frequency, the frequency of the main clock signal MCLK passes through intermediate frequency stages of frequencies between the first frequency and the second frequency.

In this case, two conditions should be satisfied to prevent the display apparatus 200 from shifting to the emergency mode, allowing the image to be displayed in the normal mode continuously.

The first of the two conditions is that when the frequency of the main clock signal MCLK sequentially passes through the intermediate frequency stages, the frequency adjustment change of the main clock signal MCLK remains the same or within the predetermined maximum change determined by the phase fixing part 212. For example, the predetermined maximum change may be about 1 Hz.

The second condition is that when the frequency of the main clock signal MCLK sequentially passes through the intermediate frequency stages, the main clock signal MCLK remains in each intermediate frequency stage for at least one frame.

In addition, in the present embodiment, when the display apparatus 200 is changed from the first image mode to the second image mode to display the image, preferably, the following two conditions are further satisfied.

The first of these additional conditions is that when the frequency of the main clock signal MCLK passes through the intermediate frequency stages, the main clock signal MCLK maintains each intermediate frequency for preferably about the same duration.

The second additional condition is that when the frequency of the main clock signal MCLK sequentially passes through the intermediate frequency stages, the frequency adjustment change of the main clock signal MCLK in each stage preferably remains substantially the same.

When the first frequency is 60 Hz, the second frequency is 50 Hz, and the predetermined maximum change is 1 Hz, the conditions as mentioned above will be explained referring to additional figures.

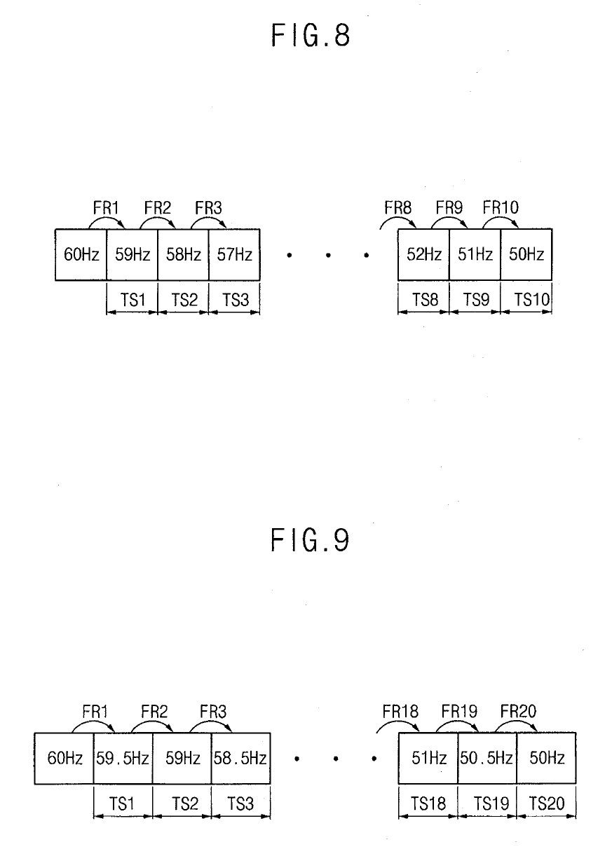

FIG. 8 is a block diagram illustrating a change in the frequency of a main clock signal from 60 Hz to 50 Hz by 1 Hz-changes in the display system in FIG. 1. FIG. 9 is a block diagram illustrating a change in the frequency of a main clock signal from 60 Hz to 50 Hz by 0.5 Hz-changes in the display system in FIG. 1.

Referring to FIG. 8, the frequency of the main clock signal MCLK is decreased through 10 stages, from 60 Hz to 50 Hz in 1 Hz-changes. More specifically, the adjustment changes FR1, FR2, FR3, . . . , FR8, FR9, FR10 of main clock signal MCLK between each intermediate frequency stage remain constant at 1 Hz.

In addition, when the frequency of the main clock signal MCLK is decreased through 10 stages from 60 Hz to 50 Hz in 1 Hz-changes, the durations TS1, TS2, TS3, . . . , TS8, TS9, TS10 for which the main clock signal MCLK remained in each intermediate frequency stage remained substantially the same and were at least one frame long.

Alternatively, referring to FIG. 9, the frequency of the main clock signal MCLK is decreased through 20 stages, from 60 Hz to 50 Hz in 0.5 Hz-changes. More specifically, the frequency adjustment changes FR1, FR2, FR3, . . . , FR18, FR19, FR20 of the main clock signal MCLK between each intermediate frequency stage remain constant at about 0.5 Hz. The 0.5 Hz change is within the predetermined maximum change of 1 Hz.

In addition, when the frequency of the main clock signal MCLK is decreased through 20 stages from 60 Hz to 50 Hz by 0.5 Hz-changes, the durations TS1, TS2, TS3, . . . , TS18, TS19, TS20 for which the main clock signal MCLK remained in each intermediate frequency stage remained substantially the same and were at least one frame long.

Accordingly, when the frequencies of the main clock signal MCLK sequentially passes through the intermediate frequency stages, the frequency of the main clock signal MCLK is the same or lower than the predetermined maximum change. When the duration in each stage is maintained for at least one frame, the display apparatus 200 may continuously display the image not in the emergency mode but in the normal mode. Thus, the display apparatus 200 may display the image having better quality regardless of the change in the frequency of the main clock signal MCLK.

The display system according to the present embodiment changes the frequency of the main clock signal MCLK according to the image mode to decrease the overall power consumption. For example, the display system according to the present embodiment is driven with the frequency of 60 Hz to display a dynamic image having a better quality, and is driven with the frequency of 50 Hz or 40 Hz (both of which are lower than 60 Hz) to display a static image such as a word program having a lower quality. This way, the overall power consumption of the display apparatus 200 may be decreased. When the display system is a laptop, the battery may last longer due to the decrease in power consumption.

### Embodiment 2

### Display System

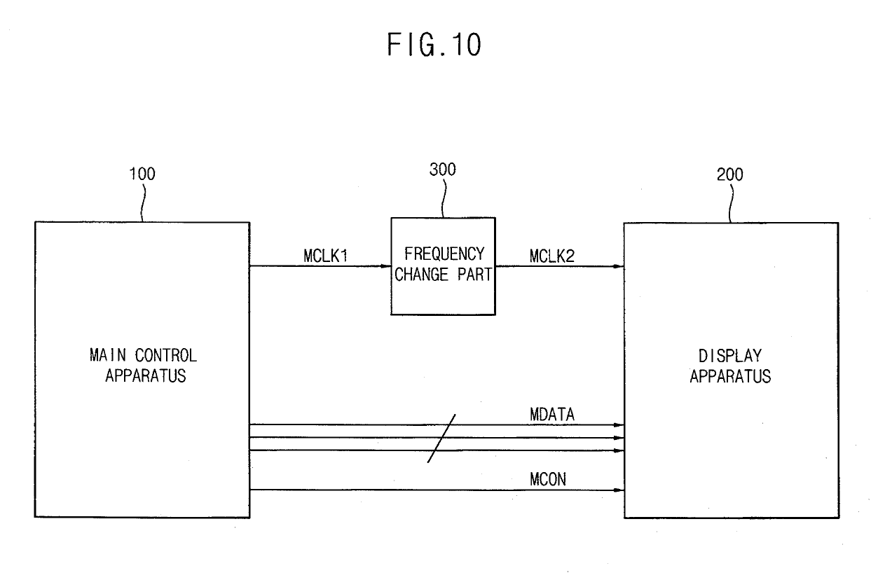

FIG. 10 is a block diagram illustrating a display system according to a second embodiment of the present invention.

Referring to FIG. 10, the display system according to the present embodiment includes a main control apparatus 100, a frequency change part 300 and a display apparatus 200.

The main control apparatus 100 generates an image control signal and a first main clock signal MCLK1 which are output to the display apparatus 200 and the frequency change part 300. In this case, the image control signal includes a main image signal MDATA having an image data, and a main control signal MCON having various control signals except the main image signal MDATA.

The main control apparatus 100 outputs a first main clock signal MCLK1 having a frequency that is adjusted to the image mode. For example, the main control apparatus 100 outputs a first main clock signal MCLK1 having a first frequency in a first image mode, and outputs a second main clock signal MCLK2 having a second frequency in a second image mode.

The frequency change part 300 receives the first main clock signal MCLK1 from the main control apparatus 100 and outputs the second main clock signal MCLK2 to the display apparatus 200.

When the first main clock signal MCLK1 is applied to the frequency change part 300 without changing the frequency, the frequency change part 300 outputs the second main clock signal MCLK2 having the same frequency as the first main clock signal MCLK1.

However, when the first main clock signal MCLK1 applied to the frequency change part 300 is changed from the first frequency to the second frequency, the frequency change part 300 outputs the second main clock signal MCLK2 that passed through the intermediate frequency stages between the first frequency and the second frequency.

The display apparatus 200 receives the main image data MDATA and the main control signal MCON from the main control apparatus 100, and receives the second main clock signal MCLK2 from the frequency change part 300 to output an image in response to the main image data MDATA, the main control signal MCON and the second main clock signal MCLK2.

The display apparatus 200 displays the image in either a normal mode or an emergency mode based on a frequency adjustment change of the second main clock signal MCLK2. Particularly, when the frequency adjustment change of the second main clock signal MCLK2 is within a predetermined maximum change, the display apparatus 200 displays the image in the normal mode. When the frequency adjustment change of the second main clock signal MCLK2 exceeds the predetermined maximum change, the display apparatus 200 displays the image in the emergency mode. The display apparatus 200 of the present embodiment is the same as in the first embodiment, and thus, any repetitive explanation will be omitted.

The frequency of the second main clock signal MCLK2 outputted from the frequency change part 300 is changed within the predetermined maximum change and is maintained at each intermediate frequency stage for at least one frame, so that the display apparatus 200 may display the image not in the emergency mode but in the normal mode.

Furthermore, the frequency adjustment changes of the second main clock signal MCLK2 between intermediate frequency stages are preferably substantially constant, and the duration for which the second main clock signal MCLK2 remains at each of the intermediate frequency stages is preferably substantially constant as well.

Accordingly, when the main control apparatus 100 rapidly decreases the frequency of the first main clock signal MCLK1 from the first frequency to the second frequency to decrease power consumption, the frequency change part 300 receives the first main clock signal MCLK1 and outputs the second main clock signal MCLK2 that has been gradually shifted through intermediate frequency stages from the first frequency to the second frequency. This way, the display apparatus 200 may display the image not in the emergency mode but in the normal mode to enhance display quality.

### <Method for Driving a Display System>

Referring to FIGS. 1 to 10 again, a method for driving the display system according to the present embodiment will be explained.

First, the image control signal and the main clock signal MCON are generated from the main control apparatus 100. In this case, the image control signal includes the main image signal MDATA having the image data, and the main control signal MCON having the various control signals except the main image signal MDATA.

Then, when the image mode of the image control signal changes, the first frequency of the main clock signal MCON is sequentially changed to the second frequency by passing through intermediate frequency stages between the first and second frequencies.

Finally, the display apparatus 200 receives the image control signal and the main clock signal MCON to display the image to the outside. In this case, when the frequency of the main clock signal MCON is changed by no more than the predetermined maximum change, the display apparatus 200 displays the image in normal mode.

In the present embodiment, the frequency of the main clock signal MCLK should be changed by the predetermined maximum change or less, and should remain at each intermediate frequency stage for at least one frame. This way, the display apparatus 200 may continuously display the image in normal mode.

Furthermore, the frequency adjustment changes of the main clock signal MCLK passing through the intermediate frequency stages are preferably substantially constant, and the duration for which the main clock signal MCLK remains in each intermediate frequency stage are preferably the same as well.

Accordingly, the main clock signal MCLK is gradually shifted through the intermediate frequency stages from the first frequency to the second frequency before being output, so that the display apparatus 200 may display the image in the normal mode.

According to the present invention, the frequency of the main clock signal is changed according to the displayed image mode, so that overall power consumption may be decreased. For example, the image is displayed in the first frequency to display the dynamic image having a better quality, and the image is displayed in the second frequency lower than the first frequency to display the static image having a lower quality so that the power consumption of the display system may be decreased.

When the frequency of the main clock signal is rapidly shifted from the first frequency to the second frequency, the display apparatus may display the image in the emergency mode for a predetermined time by inner characteristics of the display apparatus. Thus, to prevent the display apparatus from displaying in the emergency mode, the frequency of the main clock signal is shifted through multiple intermediate frequency stages between the first frequency and the second frequency. This way, the emergency mode is not triggered and the display apparatus may continuously display the image in the normal mode.

Having described the embodiments of the present invention and its advantage, it is noted that various changes, substitutions and alterations can be made herein without departing from the spirit and scope of the invention as defined by the appended claims.

What is claimed is:

1. A display system comprising:
a main control apparatus generating an image control signal having an image data and a main clock signal that changes from a first frequency to a second frequency in response to a change in image mode from a first image mode to a second image mode, wherein the change from the first frequency to the second frequency includes changing through at least one intermediate frequency stage between the first frequency and the second frequency; and
a display apparatus receiving the image control signal and the main clock signal to display an image.

2. The display system of claim 1, wherein the main clock signal remains in the intermediate frequency stage for at least one frame.

3. The display system of claim 2, wherein the main clock signal changes through more than one intermediate frequency stages and maintains each intermediate frequency for substantially the same duration.

4. The display system of claim 1, wherein the display apparatus comprises:
a timing control part outputting a data driving control signal and a gate driving control signal in response to the image control signal and the main clock signal and controlling the image to be displayed in a normal mode when a frequency adjustment change of the main clock signal is less than or equal to a predetermined maximum change;
a data driving part outputting a data signal in response to the data driving control signal;
a gate driving part outputting a gate signal in response to the gate driving control signal; and
an image display part receiving the data and gate signals to display the image.

5. The display system of claim 4, wherein the frequency adjustment change of the main clock signal is the same as or less than the predetermined maximum change.

6. The display system of claim 5, wherein the predetermined maximum change is about 1 Hz.

7. The display system of claim 5, wherein there are more than one intermediate frequency stages and the frequency adjustment change of the main clock signal between successive intermediate frequency stages remains substantially the same.

8. The display system of claim 4, wherein the timing control part comprises:
a phase fixing part receiving the main clock signal to output an inner clock signal having a fixing frequency and outputting a mode selection signal to select one of a normal mode and an emergency mode depending on whether the frequency adjustment change of the main clock signal exceeds the predetermined maximum change or not; and
a signal control part outputting the data driving control signal and the gate driving control signal for at least one of the normal and emergency modes to be driven in response to the image control signal, the inner clock signal and the mode selection signal.

9. The display system of claim 1, wherein the main control apparatus comprises:
a main control part outputting a mode decision signal that affects the image control signal and the image mode; and
a clock signal generating part outputting the main clock signal in response to the mode decision signal.

10. A display system comprising:
a main control apparatus generating an image control signal and a first main clock signal;
a frequency change part receiving the first main clock signal to output a second main clock signal when the first main clock signal changes from a first frequency to a second frequency, wherein the change from the first frequency to the second frequency includes the second main clock signal changing through at least one intermediate frequency stage between the first frequency and the second frequency; and
a display apparatus receiving the image control signal and the second main clock signal to display an image.

11. The display system of claim 10, wherein the second main clock signal remains in the intermediate frequency stage for at least one frame.

12. The display system of claim 11, wherein the second main clock signal changes through more than one intermediate frequency stages and maintains each intermediate frequency for substantially the same duration.

13. The display system of claim 10, wherein the display apparatus comprises:
a timing control part outputting a data driving control signal and a gate driving control signal in response to the image control signal and the second main clock signal and controlling the image to be displayed in a normal mode when a frequency adjustment change of the second main clock signal is less than or equal to a predetermined maximum change;
a data driving part outputting a data signal in response to the data driving control signal;
a gate driving part outputting a gate signal in response to the gate driving control signal; and
an image display part receiving the data and gate signals to display the image.

14. The display system of claim 13, wherein the frequency adjustment change of the second main clock signal is the same as or less than the predetermined maximum change.

15. The display system of claim 14, wherein there are more than one intermediate frequency stages and the frequency adjustment change of the second main clock signal between each intermediate frequency stages remains substantially the same.

16. A method for driving a display system, the method comprising:
generating a main clock signal having an image control signal and a first frequency from a main control apparatus to drive an image in a first mode;
sequentially changing the main clock signal through intermediate frequency stages between the first frequency and a second frequency in response to a change from the first image mode to a second image mode; and
displaying an image using a display apparatus receiving the main control signal and the main clock signal.

17. The method of claim 16, wherein the main clock signal remains in the intermediate frequency stage for at least one frame.

18. The method of claim 16, wherein the frequency adjustment change of the main clock signal is the same as or less than the predetermined maximum change when the frequency of the main clock signal is changed within the predetermined maximum change and the display apparatus displays the image in a normal mode.
